(19) United States
(12) Patent Application Publication
(10) Pub. No.: US 2016/0176229 A1
(43) Pub. Date: Jun. 23, 2016

(54) COMPOSITE SHEET MANUFACTURING METHOD AND SHEET OBTAINED

(71) Applicant: Arturo ALVAREZ FEROS, Vedra (A Coruna) (ES)

(72) Inventor: Arturo ALVAREZ FEROS, Vedra (A Coruna) (ES)

(21) Appl. No.: 14/575,133

(22) Filed: Dec. 18, 2014

(51) Int. Cl. B44F 1/06; F21V 11/00; B05D 3/00; B05D 1/02; B05D 5/06

(52) U.S. Cl. CPC B44F 1/06; B05D 1/02; B05D 5/06; B05D 3/002; F21V 11/00

(57) ABSTRACT

A composite sheet preparation method, which comprises preparing a mesh made of metal wires (2), spraying liquid silicone on said mesh to cover the wires (2) with a layer (6) and close at least part of the grids with a sheet of resin (7), and drying the covered mesh at room temperature.

### FIELD OF THE INVENTION

The present invention relates to a composite sheet manufacturing method, as well as to the obtained sheet, which has exceptional characteristics for the use thereof in furniture, lighting and construction in general.

The sheet of the invention has a mesh structure that is highly resistant and, at the same time, it is transparent, which makes it ideal for use as a closing element in lamps and as a decorative element in furniture.

### BACKGROUND OF THE INVENTION

Flat structures in the form of mesh, specifically metal, are widely used in construction, furniture and lighting, due to the fact that, along with their high resistance, they enable an open closure to be obtained that enables light and air to easily pass through.

Structures of the type mentioned made up of metal rods or metal bars are known. By their very nature, these structures do not enable attractive finishes to be obtained and, moreover, they do not completely prevent one from seeing through the same. Another drawback of the aforementioned structures is the high rigidity and weight thereof, specifically those made up of metal strips, which means that their use is limited to closing flat surfaces.

### DESCRIPTION OF THE INVENTION

The present invention has as its object a manufacturing method of composite sheets that, along with the high resistance thereof, have the advantages of the possibility of obtaining both flat and curved shapes, always offering a high-quality and very attractive finish, which is translucent, and at the same time defining a complete closure, which prevents one from clearly seeing through it.

The sheet of the invention has, compared to the known structure types, the following advantages.
a) Durability.—it is a material that keeps the characteristics intact for a long period of time. The material has been subjected to a number of corrosion and aging tests that are equivalent to its use for more than 15 years in a severely corrosive environment.
b) Flammability.—The material has low flammability and is therefore appropriate for use in lamps and furniture. According to the tests carried out in laboratories applying the UNE-EN-60695-2-12: 01 standards, neither combustion nor flames are produced after the glow wire is applied to the surface of the mesh.
c) Simple maintenance.—here the search was focused on a product that enabled simple maintenance. The cleaning thereof consists of a damp cloth to which a neutral soap for cleaning common stains may also be applied.
d) Malleable.—the components that make up the material enable it to be very flexible when creating shapes.
e) Rigidity.—enables these shapes to be maintained over time.
f) Translucent.—enables light to pass through.
g) Odorless.

The method of the invention starts with the preparation of a mesh made up of metallic wires. The nature and cross-section of these wires, as well as the size of the grids, depends on the characteristics desired based on the application that the sheet will have.

Once the mesh with the desired characteristics has been obtained, a silicone solution is applied on the same in a sufficient quantity to cover all the wires and close at least part of the grids. Then, the mesh is dried at room temperature until the applied silicone is completely dry.

A sheet made up of a metal mesh-based support or reinforcement and a coating formed of solid silicone is obtained through the method described.

The metal mesh provides the sheet of the invention with a high resistance, at the same time as the shape thereof As for the silicone, it provides an excellent finish and also serves as a closing means for all or part of the grids, with the possibility of being translucent and in different colors.

The sheet of the invention being applied as a closing element for lamps enables a passage of light that is appropriate for achieving a decorative lighting in indoor and outdoor spaces.

Due to the resistance and durability thereof, the sheet of the invention may be applied in furniture, construction, etc., as a decorative element.

Different finishes and colors with a smooth and warm texture, which are fundamental aspects to incorporate into lamp and furniture design, may be obtained by selecting the characteristics of the mesh and the silicone applied.

The sheet of the invention, due to the make-up thereof, enables different shapes and sizes to be made, for which the metal mesh may be cut and shaped before the silicone is applied.

### BRIEF DESCRIPTION OF THE DRAWINGS

The attached drawings show, by way of a non-limiting example, the different phases of the manufacturing process, as well as a possible make-up of the obtained sheet, where:

FIG. 1 is a plan view of the base metal mesh.

FIG. 2 is a representation of the liquid silicone application operation.

FIG. 3 is a plan view of the obtained composite sheet.

FIG. 4 is a cross-section of the composite sheet, obtained according to the cross-section line IV-IV of FIG. 2, at a larger scale.

### DETAILED DESCRIPTION OF AN EMBODIMENT

The method of the invention starts with the preparation of a metal mesh (1) made up of metal wires (2), which delimit grids (3). The wires (2) may run along two perpendicular directions, at an equal distance to each other, to delimit square grids (3).

The wires (2) may be steel or another metal.

The mesh (1) may be flat, delimited by straight edges, or shaped into curved surfaces and edges, depending on the object to be made.

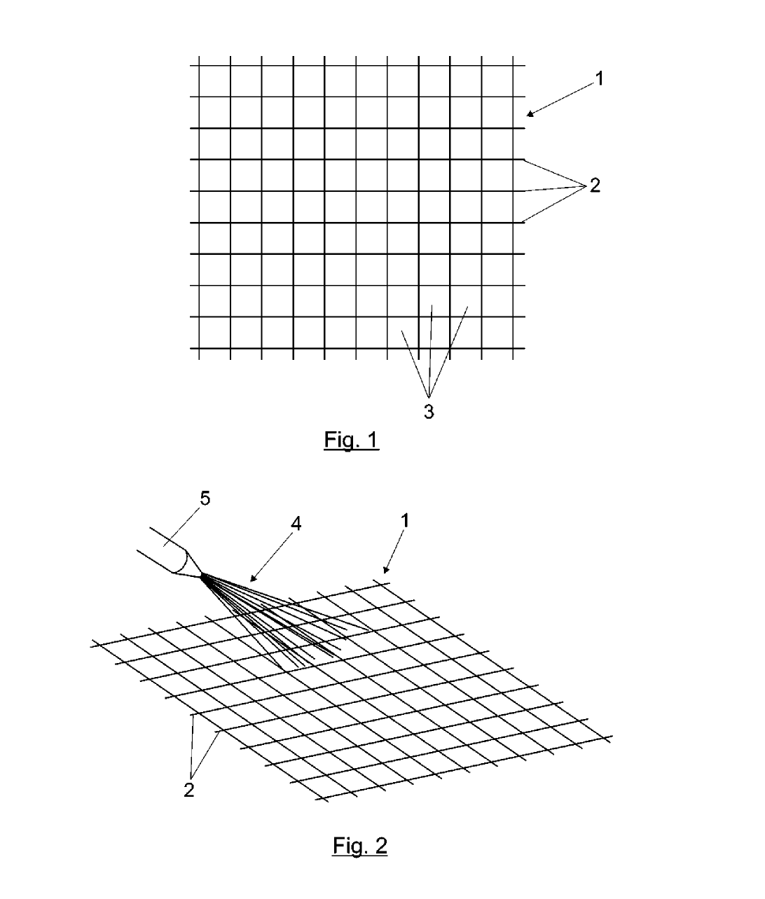

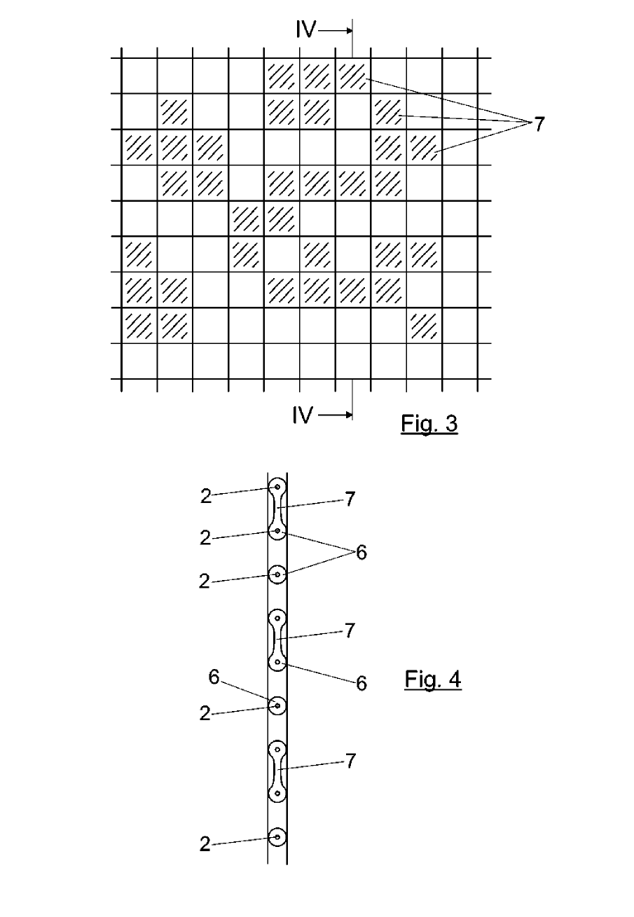

A silicone-based coating is applied on the mesh of FIG. 1. According to what is shown in FIG. 2, this application may be made by means of spraying (4) the liquid silicone with a gun (5), thus applying an amount of silicone with a distribution that enables all the wires (1) of the mesh to be covered with a layer (6) of silicone, as well as closing at least part of the grids by means of a film (7), as shown in FIGS. 3 and 4.

The number and distribution of the grids closed with the film (7) are selected according to the application of the sheet and the desired effects. The color of the applied silicone may equally be selected.

Once the silicone has been applied in the manner described, the mesh is dried until the silicone has completely solidified, thus obtaining a final product consisting of a sheet made up of a metal mesh, which serves as a resistant reinforcement of the sheet, and a silicone-based coating, which provides the appearance and visible surface of the sheet.

1. A method for preparing a composite sheet comprising:
a) Preparing a mesh made of metal wire;
b) Spraying liquid silicone on said mesh at room temperature until covering all the wires of the mesh and closing part of the grids thereof;
c) Drying the covered mesh at room temperature until the silicone has solidified.

2. The method according to claim 1, wherein before the silicone is applied, the metal mesh is cut and shaped according to the geometry of the final product to be obtained.

3. A composite sheet comprising a metal mesh and a silicone-based coating material, which adheres to the wires of the mesh and closes at least part of the grids of said mesh.
